(19) United States
(12) Patent Application Publication
(10) Pub. No.: US 2026/0175697 A1
(43) Pub. Date: Jun. 25, 2026

(54) MOVEMENT CONTROL SYSTEM FOR AN ELECTRICITY-CONDUCTING CONNECTOR ASSEMBLY OF A MOBILE MACHINE

(71) Applicant: Caterpillar Inc., Peoria, IL (US)

(72) Inventors: Ian A. TIGGEMANN, Peoria, IL (US); Antony S. Paul VINCENT, Chennai, Tamil Nadu (IN)

(73) Assignee: Caterpillar Inc., Peoria, IL (US)

(21) Appl. No.: 18/986,892

(22) Filed: Dec. 19, 2024

(51) Int. Cl. B60L 5/20

(52) U.S. Cl. CPC B60L 5/20

(57) ABSTRACT

A rail connector assembly for an electrically powered mobile machine includes a boom assembly with a first end and a second end, an arm assembly having a first end coupled to the boom, and a second end, and a contactor assembly coupled to the second end of the arm assembly. The rail connector assembly further includes a movement control system for selectively locking the arm assembly in a fixed locking position with respect to the boom assembly, wherein the movement control system limits movement of the arm assembly during an unlocking position.

### TECHNICAL FIELD

The present disclosure relates generally to an electricity-conducting connector assembly for a mobile machine, and more particularly, to a movement control system for an electricity-conducting connector assembly.

### BACKGROUND

Dynamic energy transfer systems may include mobile machines, such as industrial machines, that receive power from electricity-conducting rail systems during travel. In such systems, an electricity-conducting connector assembly may be used to connect the mobile machine to the rail system that provides electrical power to the mobile machine. In some systems, the electricity-conducting connector assembly may include a boom assembly that extends from the mobile machine and a trailing arm assembly that extends from the boom assembly to the rail system. As the mobile machine may be free steering, and the ground on which the mobile machine is traversing may be uneven, the mobile machine may move in multiple directions relative to the rail system during travel. Such movement may result in breaking contact between the mobile machine and the rail system.

U.S. Patent No. 8,584,774, issued on Nov. 19, 2010 (“the ’774 patent”), describes a movement control system including a centralizing device movably associated with a support member and configured to receive a drill rod. The centralizing device includes a movable jaw and a latch arm connected to the jaw and configured to move the jaw between an open position and a closed position for retaining the drill rod. Furthermore, the latch arm has a locking feature configured to hold the latch arm in a locked position to thereby hold the jaw in the closed position. While the system described in the ’774 patent may be helpful in some circumstances, the centralizing device described may be insufficient for addressing the structure and functions associated with an electricity-conducting connector assembly of a mobile machine.

The movement control system of the present disclosure may solve one or more of the problems set forth above and/or other problems in the art. The scope of the current disclosure, however, is defined by the attached claims, and not by the ability to solve any specific problem.

### SUMMARY

In one aspect, a rail connector assembly for an electrically powered mobile machine includes a boom assembly with a first end and a second end, an arm assembly having a first end coupled to the boom, and a second end, and a contactor assembly coupled to the second end of the arm assembly. The rail connector assembly further includes a movement control system for selectively locking the arm assembly in a fixed locking position with respect to the boom assembly, wherein the movement control system limits movement of the arm assembly during an unlocking position.

In another aspect, a rail connector assembly for an electrically powered mobile machine includes a boom assembly with a first end and a second end, a trailing arm assembly having a first end coupled to the boom, and a second end, and a contactor assembly coupled to the second end of the trailing arm assembly. The rail connector assembly also includes a movement control system including a pair of opposing and movable locking wings movable to selectively lock the trailing arm assembly in a fixed locking position with respect to rotation about a substantially vertical axis.

In yet another aspect, a method of controlling movement of a rail connector assembly for an electrically powered mobile machine is provided. The rail connector assembly includes a boom assembly with a first end and a second end, an arm assembly having a first end coupled to the boom, and a second end, a contactor assembly coupled to the second end of the arm assembly, and a movement control system. The method includes moving the movement control system between a locking position and an unlocking position, the movement to the locking position including controllably moving a pair of locking wings about a common axis.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of a mobile machine power system including an electricity-conducting connector assembly with a movement control system, according to aspects of the disclosure.

FIG. 2 is a perspective view of the movement control system of FIG. 1 in an open position and attached to a distal end of a boom assembly.

FIG. 3 is an isolated view of the movement control system FIG. 2.

FIG. 4 is an exploded view of a wing assembly of the movement control system of FIG. 2.

FIG. 5 is a perspective view of a wing of the wing assembly of FIG. 4.

FIG. 6 is a perspective view of the movement control system of FIG. 1 in a closed position.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

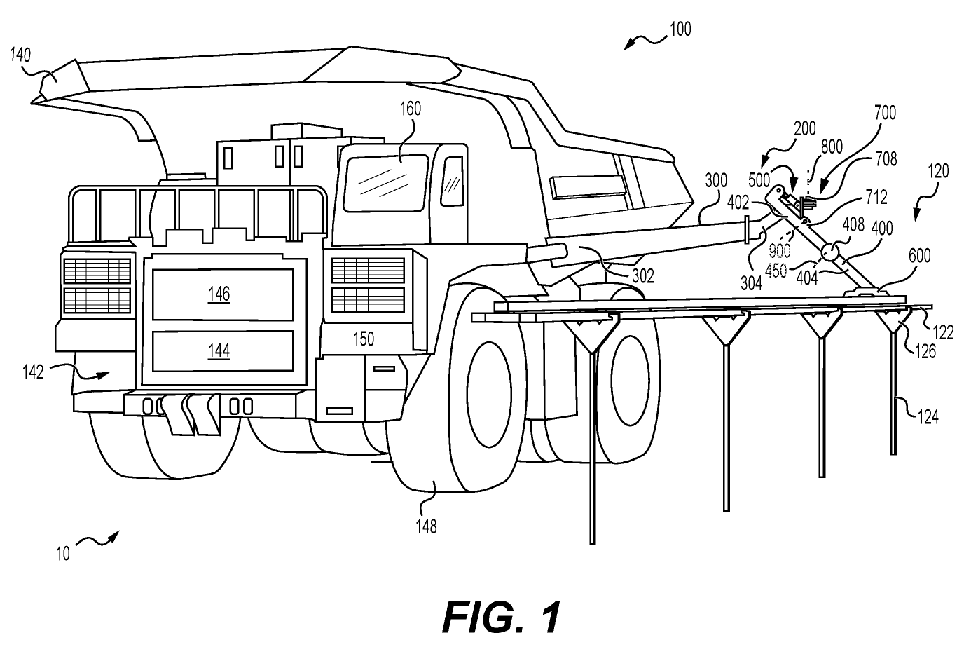

FIG. 1 depicts a mobile machine power system 100 including a mobile machine 140 that connects to an electricity-conducting rail system 120 using an electricity-conducting connector assembly 200. The electricity-conducting connector assembly 200 may include a boom assembly 300 and a trailing arm 400. The electricity-conducting connector assembly 200 may further include a movement control system 500 for selectively locking the trailing arm assembly 400 in a locked position with respect to the boom assembly 300, and limiting the movement of the trailing arm assembly 400 in an unlocked position.

As shown in FIG. 1, the mobile machine 140 includes an electric drive system 142 having at least one electric motor 144 for propelling the mobile machine 140. The electric drive system 142 may also optionally include at least one battery system 146 for storing energy to be supplied to the at least one electric motor 144. The electric drive system 142 drives a set of ground-engaging elements 148, such as tires or continuous tracks, for propelling and maneuvering the mobile machine 140. The mobile machine 140 also includes a frame/body 150 which supports the mobile machine’s mechanical components, including the electricity-conducting connector assembly 200. The mobile machine 140 may include either a hybrid or an all-electric power system, and the electricity-conducting rail system 120 may be applied to either system. In a hybrid system, an internal combustion engine may be included as an additional motive drive system, in addition to the one or more electric motor 144. In either system, all-electric, or hybrid, a battery system 146 may be included. The mobile machine 140 and its various systems may be controlled via a machine operator located in the operator cabin 160, or the mobile machine 140 may be semi- or fully-autonomous or remotely operated.

The mobile machine 140 is free-steering, allowing the operator of the machine (or autonomous control system) to freely control the travel direction and route of the mobile machine 140. Thus, the mobile machine 140 is configured to travel (e.g., in a free-steering manner) selectively along a work route or path within a job site, with the electricity-conducting rail system 120 positioned generally along the travel route or path. The mobile machine 140 of FIG. 1 is shown in the context of a mining haul truck, which is commonly used for transporting ore in a mine environment. The present disclosure is not so limited, however, and other types of mobile machines are within the scope of the present disclosure, including articulated trucks, asphalt pavers, backhoe loaders, drills, rope shovels, excavators, forest machines, hydraulic mining shovels, material handlers, motor graders, off-highway trucks, pipelayers, road reclaimers, telehandlers, track loaders, underground mining dump loaders and trucks, wheel loaders, wheel tractor-scrapers, or other machines.

The electricity-conducting rail system 120 includes a plurality of elevated conductor rails 122 connected to a power source (e.g., a power grid, generator, or energy storage devices, not shown). The conductor rails 122 may be supported by a plurality of ground-engaging support poles 124 and rail bracket assemblies 126.

The electricity-conducting connector assembly 200 electrically connects the mobile machine 140 to the electricity-conducting rail system 120. As noted above, the electricity-conducting connector assembly 200 includes a boom assembly 300, the trailing arm assembly 400, and a contactor assembly 600.

The boom assembly 300 includes a first, proximal end 302 and a second distal end 304. The boom assembly 300 extends generally horizontally from a side of the mobile machine 140, such that the proximal end 302 connects to the frame 150 of the mobile machine 140 and the distal end 304 extends generally away from the mobile machine 140

The trailing arm assembly 400 includes a first, proximal end 402 and a second, distal end 404, and forms a mechanical and electrical connection between boom assembly 300 and the contactor assembly 600. The proximal end 402 of the trailing arm assembly 400 may be pivotably coupled to the distal end 304 of the boom assembly 300 by a multi-axis pivot joint 700 (explained further below), such that the trailing arm assembly 400 may pivot about the distal end 304 of the boom assembly 300. The distal end 404 of the trailing arm assembly 400 may be coupled to the contactor assembly 600. Between the proximal end 402 and the distal end 404 may be an intermediate folding joint 408 aligned with a folding axis 450, about which the trailing arm assembly 400 may fold.

The trailing arm assembly 400 may rotate or fold about the intermediate folding joint 408 between an open configuration (FIG. 1) and a stowed configuration (not shown). In the open configuration, the trailing arm assembly 400 extends rearward (e.g., in a trailing traveling direction) and vertically down (e.g., towards the ground 10) from the distal end 304 of the boom assembly 300, such that the contactor assembly 600 at the distal end 304 of the boom assembly 300 engages atop the electricity-conducting rail system 120 when the mobile machine 140 is a particular distance from the electricity-conducting rail system 120. In the stowed configuration, the trailing arm assembly 400 may be raised about multi-axis pivot joint 700 and folded about the intermediate folding joint 408 such that the contactor assembly 600 is at or near the proximal end 402 of the trailing arm assembly 400 and the distal end 304 of the boom assembly 300.

As noted above, the trailing arm assembly 400 may further include a multi-axis pivot joint 700 at the proximal end 402 that connects the trailing arm assembly 400 to the boom assembly 300. The multi-axis pivot joint 700 may include a swing pivot 708 aligned with a first, vertical axis of rotation 800 about which the trailing arm 400 may rotate, pivot, or swing in a side-to-side motion relative to the boom assembly 300, such that the contactor assembly 600 can move closer or farther away from the frame/body 150 of the mobile machine 140. The multi-axis pivot joint 700 may further include a fold pivot 712 aligned with a second, horizontal axis of rotation 900 that allows for upward and downward motion of the proximal end 402 of the trailing arm assembly 400 relative to the boom assembly 300, to allow for folding and unfolding of the trailing arm 400.

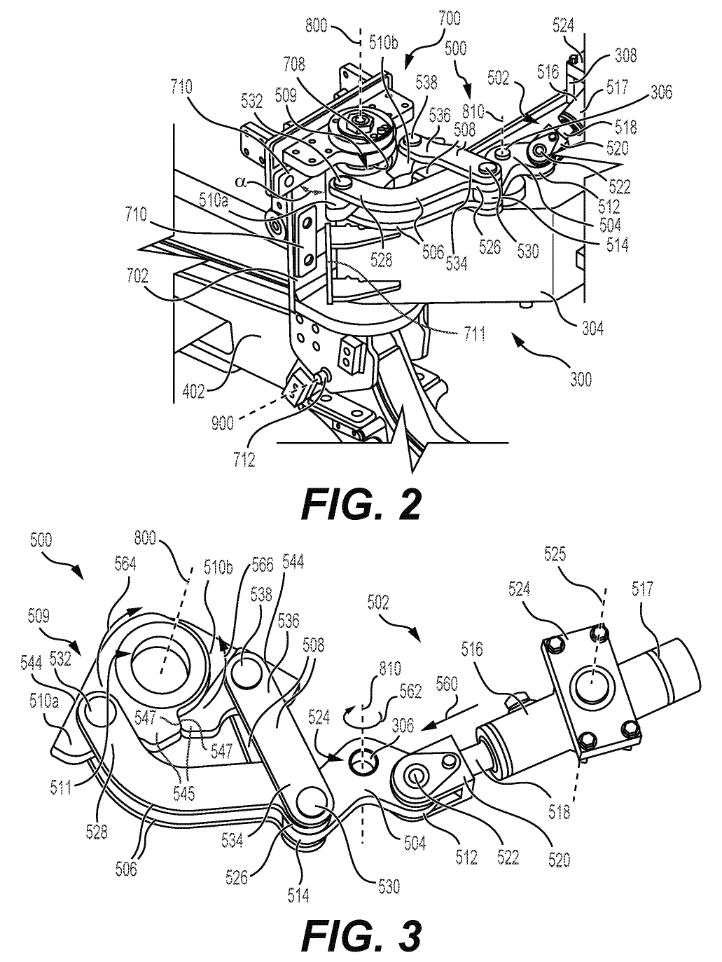

FIGS. 2 and 3 show perspective views of the movement control system 500 in an open position, attached to the distal end 304 of the boom assembly 300. As shown in FIG. 2, the movement control system 500 may include an actuator assembly 502, one or more first linkages 506, and one or more second linkages 508. The movement control system 500 may further include a bell crank 504 coupling the actuator assembly 502 at a first, actuator end 512 to the first and second linkages 506, 508 at a second linkage end 514. The first and second linkages 506, 508 may each connect to a wing assembly 509 distal of the actuator assembly 502 with respect to the orientation of the mobile machine 140. The wing assembly may include at least a pair of wings - left wing 510a and a right wing 510b rotatably connected to one another about a shared axis (vertical axis of rotation 800). The left wing 510a of the wing assembly 509 may be connected to the first linkages 506, and the right wing 510b of the wing assembly 509 may be connected to the second linkages 508. The movement control system 500 may also include a pair of hard stops 711 located on each side of the boom distal end 304. While only one hard stop 711 is shown in FIG. 2, the opposite side of boom distal end 304 includes the same hard stop 711 oriented in the same manner.

The actuator assembly 502 may include a linear fluid actuator, such as a hydraulic cylinder 516, including a rod end 518 and a cylinder end 517, with the rod end 518 coupled to the bell crank 504. The rod end 518 may include a head 520 that rotatably or pivotably connects to the actuator end 512 of the bell crank 504 via a pin 522. The hydraulic cylinder 516 may be pivotably coupled (about axis 525 (FIG. 3)) to a top surface of the distal end 304 of the boom assembly 300, for example by a plate 524 attached to risers 308 (FIG. 2). The cylinder 516 may be controllably connected to a fluid system (not shown) for selectively extending and retracting rod end 518. In the above description, the actuator assembly 502 is characterized as a linear hydraulic actuator. In other examples, the actuator assembly 502 may be a pneumatic actuator or any other suitable type of actuator.

The bell crank 504 may pivot about a stationary pin 306 (FIG. 2) extending from a top surface of the distal end 304 of the boom assembly 300 along a crank axis 810. The actuator end 512 and second linkage end 514 of the bell crank 504 may be angular disposed about the pin 306 and associated central opening 524 (FIG. 3) such that the bell crank 504 has a general boomerang or V shape.

The one or more first linkages 506 may have a generally planar “S” shape with a proximal end 526 pinned to the second linkage end 514 of the bell crank 504 via pin 530, and a distal end connected to the left wing 510a via pin 532. The one or more second linkages 508 may have a generally linear shape with a proximal end 534 pinned to the second linkage end 514 via pin 530, and a distal end 536 connected to the right wing 510b via pin 538. In the examples shown, the first linkages 506 may include two linkages and may be pinned to the bell crank 504 between the one or more second linkages 508. In other examples, the one or more second linkages 508 may be pinned to the bell crank 504 between a pair of first linkages 506. In other examples, the order of the one or more first linkages 506 and the one or more second linkages 508 relative to bell crank 504 may alternate.

As shown in FIGS. 2-5, the wings 510a, 510b of the wing assembly 509 may be approximately triangular, such that the wings 510a, 510b taper radially relative to the first vertical axis 800. The wings 510a, 510b may each have a planar stop surface 544 that is generally parallel to the first vertical axis 800 and faces generally towards a vertical plate 702 fixedly coupled to and extending from the trailing arm assembly 400 (FIG. 2). A central bore 511 (FIG. 3) May extend axially through the wing assembly 509 along the first vertical axis 800. The swing pivot 708 may be formed by a pin or similar structure received within the central bore 511.

FIG. 3 shows an isolated view of the movement control system 500 in an open configuration. Closing of the movement control system 500 is shown by way of the arrows depicted in FIG. 3. In particular, arrow 560 depicts movement of rod end 518 of hydraulic cylinder 516, which causes rotation of bell crank 504 shown by arrow 562, which causes coordinated rotation of wings 510a, 510b shown by arrows 564, 566.

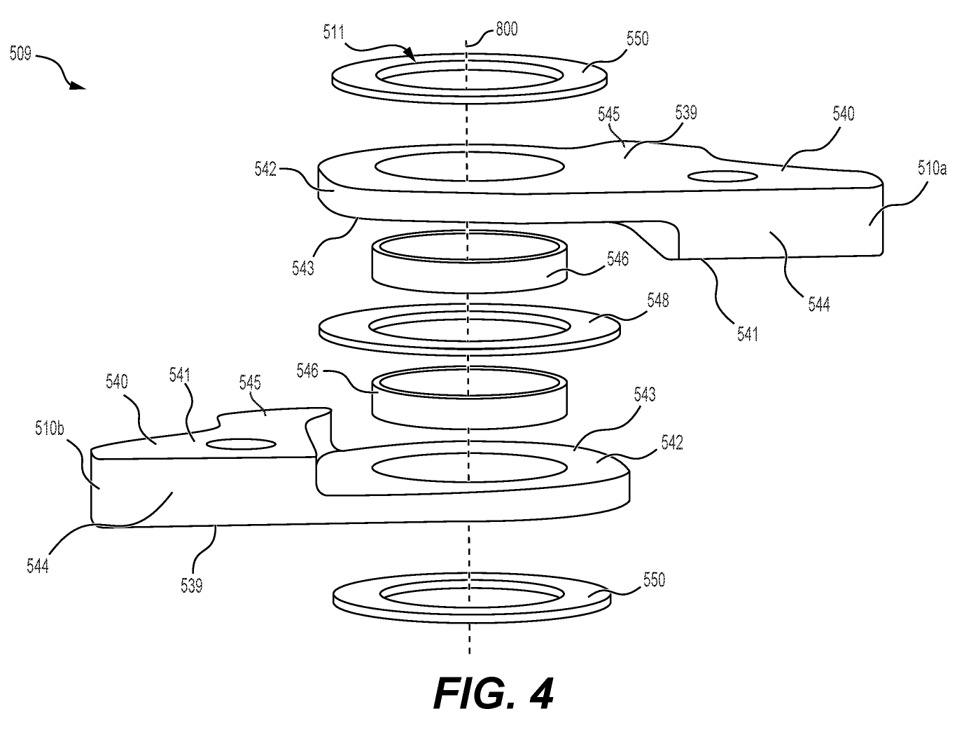

Reference will now be made to FIG. 4 depicting an exploded view of the wing assembly 509. As shown in FIG. 4, the left wing 510a and the right wing 510b may be identical, with one of the wings 510a, 510b inverted relative to the other. The left wing 510a and the right wing 510b may each have a generally circular central portion 542 and a generally triangular outer portion 540. The central bore 511 may extend through the central portion 542 of each wing. The outer portion 540 and central portion 542 may each have an exterior surface 539 normal to the first vertical axis 800 that faces away from the opposite wing 510a, 510b, such that the exterior surface 539 of each wing 510a, 510b face away from one another. The central portion 542 of each wing 510a, 510b may each have an interior surfaces 543 normal to the first vertical axis 800 that faces towards the opposite wing 510a, 510b, such that the interior surface 543 of each wing 510a, 510b faces towards the opposite wing 510a, 510b. The outer portion 540 of each wing 510a, 510b may have a protruding surface 541 opposite the respective shared exterior surface 539, that protrudes towards and faces the opposite wing 510a, 510b. For example, the protruding surface 541 of the left wing 510a may protrude downwards, and the protruding surface 541 of the right wing 510b may protrude upwards so as to provide a nesting arrangement of the left wing 510a and right wing 510b together. This nesting arrangement provides for a common vertical alignment of the planar stop surface 544 of each wing 510a, 510b.

Thus, the nesting arrangement is provided by the central portions 542 having a thickness about the first vertical axis 800 that is less than the thickness of the outer portions 540 along the first vertical axis 800. When the wing assembly 509 is fully assembled in the nesting arrangement, the central portion 542 of the left wing 510a and the central portion of the right wing 510b may abut and be axially aligned about the first vertical axis 800. Further, the protruding surface 541 of the left wing 510a may be generally aligned or coplanar with the shared exterior surface 539 of the right wing 510b, and the protruding surface 541 of the right wing 510b may be generally aligned or coplanar with the shared exterior surface 539 of the left wing 510a such that the overall thickness of the wing assembly 509 is approximately that of the thickness of the outer portion 540 when the wing assembly 509 is assembled.

When assembled, the interior surfaces 543 of each wing 510a, 510b may be separated by an inner washer 548 centered about the first vertical axis 800. In some examples, the washer 548 may be made from brass. In other examples, the inner washer 548 may be made from other suitable materials. An outer washer 550 centered about he first vertical axis 800 may be placed on the exterior surface 539 of each wing 510a, 510b. In some examples the outer washer 550 may be made from an elastomer. In other examples, the outer washer 550 may be made from other suitable materials.

Each wing 510a, 510b may have a respective bushing 546 housed within the respective central bore 511 of the respective wing 510a, 510 b. The respective bushings 546 may, for example, be made of be bonze and include a steel backing. In other examples, the bushings 546 may be made from other suitable materials.

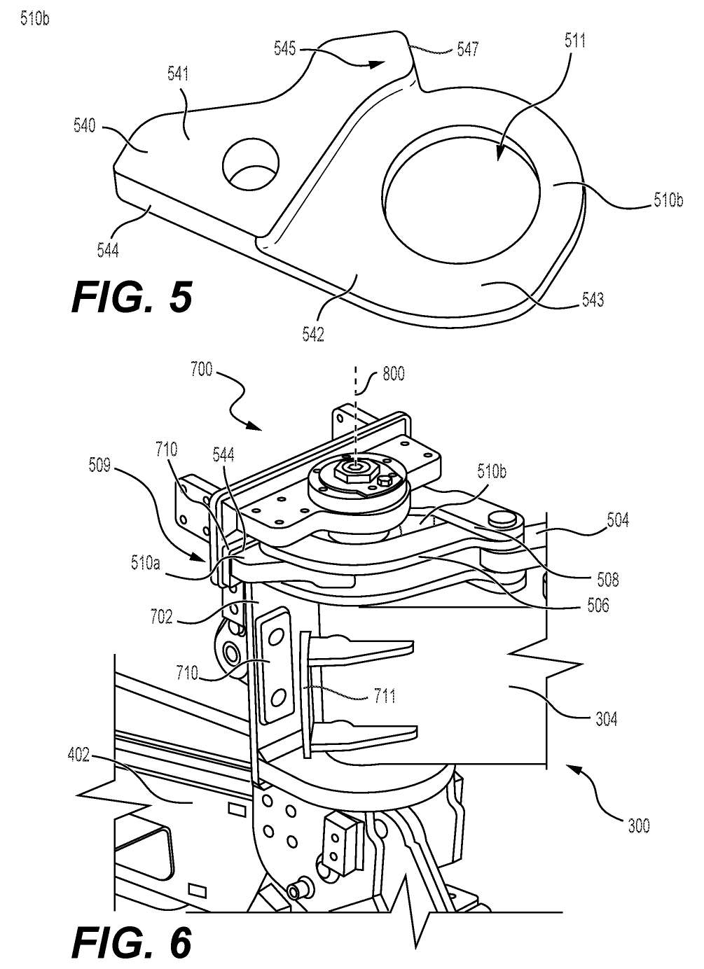

FIG. 5 is a perspective view of a wing (e.g., 510b) of the wing assembly of FIG. 4. Wing 510a and 510b each include a wing stop 545 having a wing stop surface 547. Wing stop 545 may be located on outer portion 540, but opposite planar stop surface 544. Wing stop surface 547 may also extend normal to exterior surface 539 and protruding surface 541 and may form a plane that is substantially coextensive with vertical axis of rotation 800. As shown best in FIGS. 2 and 3, wing stops 545 of each wing 510a and 510b abut one another to form a hard stop for rotational movement of the wings 510a and 510b toward the open or unlocked position shown in FIG. 3. Thus, the location of wing stops 545 define an open angle of the wings 510a and 510b that may be, for example, approximately 90° (±45°), or an α angle of approximately 45° or greater.

FIG. 6 is a perspective view of the movement control system 500 in a closed position, and attached to the distal end 304 of the boom assembly 300. In the closed position, the wings 510a, 510b of the wing assembly 509 are rotated about the first vertical axis 800 until the planar stop surface 544 (FIG. 4) of each wing abuts the vertical plate 702 or a wear member 710 on the vertical plate 702. As noted above, the vertical plate 702 is a fixed plate of the trailing arm 400, and thus movement of the vertical plate 702 serves to pivot or rotate trailing arm 400 about first vertical axis of rotation 800.

The movement or actuation of the actuator assembly 502 moves the movement control system 500 between the locked position and unlocked position. As noted above with respect to the arrows in FIG. 3, to transition from the open position (FIGS. 2 and 3) to the closed position (FIG. 6), the actuator assembly 502 actuates, and extends such that the rod end 518 of the actuator assembly 502 extends away from the cylinder end 517 (arrow 560), moving the head 520 generally towards the distal end 304 of the boom assembly 300. The extension of the actuator assembly 502 rotates the bell crank 504 about the crank axis 810, for example, in a clockwise direction (arrow 562). The rotation of the bell crank 504 moves the one or more first linkages 506 and one or more second linkages 508 towards the vertical plate 702. The movement of the first linkages 506 and second linkages 508 causes the wings 510a, 510b of the wing assembly 509 to rotate in counter directions about the first vertical axis 800 (arrows 564, 566), until contacting the vertical plate 702, such that the wing assembly 509 is in the closed position and the trailing arm 400 is in a locked position.

To transition from the closed position to the open position, the arrows depicted in FIG. 3 are reversed. In particular, the actuator assembly 502 actuates so as to retract such that the rod end 518 of the actuator assembly 502 retracts into the cylinder end 517, moving the head 520 towards the proximal end 302 of the boom assembly 300. The retraction of the actuator assembly 502 rotates the bell crank 504 about the crank axis 810, for example, in a counterclockwise direction. The rotation of the bell crank 504 moves the one or more first linkages 506 and one or more second linkages 508 away the vertical plate 702. The movement of the first linkages 506 and second linkages 508 causes the wings 510a, 510b of the wing assembly 509 to rotate in counter directions about the first vertical axis 800, such that the wings 510a, 510b no longer contact the vertical plate 702 and the wing assembly 509 is in the open or fully retracted position. In the open or fully retracted position (FIGS. 2 and 3), the wing stops 545 of each wing 510a and 510b abut one another.

As best shown in FIG. 2, in the unlocked position, the trailing arm assembly 400 may pivot about the first vertical axis 800 in either a clockwise or counter clockwise direction until the vertical plate 702 contacts a hard stop 711 fixedly attached to either side of the boom distal end 304. When the vertical plate 702 of trailing arm assembly 400 is centered between the wings 510a, 510b, hard stops 711 on each side of the boom distal end 304 may be at an angle relative to the vertical plate 702 (FIG. 2). In some examples, the angle may be approximately 45°, such that the hard stops 711 limit the rotation of the trailing arm assembly 400 to approximately 90° (±45°) about the first vertical axis 800. In other examples, angle may be different, such the vertical plate 702 may pivot a different amount about the first vertical axis 800, for examples, less than 90° or more than 90°. While rotation of the trailing arm 400 is described as being stopped by hard stops 711 of the movement control system 500, it is understood that the hard stops 711 may be removed or supplemented by planar stop surfaces 544 of each wing 510a and 510b forming rotation limiting stops for the trailing arm 400. However, in the system shown in the figures, the hard stops 711 of movement control system 500 are located about an arc smaller than an arc formed by planar stop surfaces 544 when the wings 510a and 510b are in their fullest unlocked position. Thus, hard stops 711 stop rotation of the trailing arm assembly 400 before the trailing arm assembly 400 contacts the wings 510a and 510b. Consistent with this, if the arc between the hard stops is approximately 90°, then the arc formed between planar stop surfaces 544 will be at least slightly more than approximately 90°.

In transitioning from the open position to the closed position, the movement control system 500 may center the trailing arm assembly 400 relative to the boom assembly 300. For example, if the trailing arm assembly 400 is positioned such that the vertical plate 702 contacts an outer hard stop 711 (e.g., the hard stop 711 shown in FIG. 3), as the movement control system 500 transitions to the closed position, the left wing 510a may impart a force onto the vertical plate 702, causing the trailing arm assembly 400 to rotate clockwise about the first vertical axis 800. This rotation may continue until the movement control system 500 reaches the closed position, at which point, both the left wing 510a and the right wing 510b may contact the vertical plate 702, ensuring the trailing arm assembly 400 is centered between the wings 510a, 510b, as shown in FIG. 6.

### INDUSTRIAL APPLICABILITY

The disclosed aspects of the movement control system of the present disclosure may be used to positionally lock and unlock a trailing arm assembly 400 of an electricity-conducting connector assembly 200 relative to a boom assembly 300 of the electricity-conducting connector assembly 200.

The movement control system 500 allows for relative movement of the trailing arm assembly 400 in the open position, while providing centering and locking of the trailing arm assembly 400 to the boom assembly 300 for stowage in the closed position. The position of the movement control system 500 at the distal end 304 of the boom assembly 300 allows the wing assembly 509 of the movement control system 500 to engage or disengage the vertical plate 702 of the trailing arm assembly 400. When the movement control system 500 is in the open or fully retracted position, the trailing arm assembly 400 may pivot about a first vertical axis 800 relative to the boom assembly 300, while being constrained in its range of motion by the hard stops 711 and/or wings 510a, 510b of the movement control system 500. This provides some variability or play for the dynamic engagement of the contactor assembly 600 with the electricity-conducting rail system 120 during travel of the mobile machine 140. When the movement control system 500 is in the closed position, the planar stop surface 544 of each wing 510a, 510b acts on the trailing arm assembly 400 to prevent rotation of the trailing arm assembly 400. In this closed position, the boom and trailing arm assembly 200, 400 may be moved to a stowed configuration. In transitioning between the open and closed positions, the movement control system 500 may center the trailing arm assembly 400 relative to the boom assembly 300 to position the trailing arm assembly 400 for proper stowage.

The actuator assembly 502 provides sufficient force to rotate and center the trailing arm assembly 400 despite its mass. Further, the layout of the movement control system 500 provides structural integrity, allowing the movement control system 500 to be used in harsh conditions, such as those associated with mining operations. The layout also allows the movement control system 500 to be used as a mechanical stop for the trailing arm assembly 400 (alone or in combination with hard stops 711) when the movement control system 500 is in the open position without undue wear and tear.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A rail connector assembly for an electrically powered mobile machine, comprising:
a boom assembly with a first end and a second end;
an arm assembly having a first end coupled to the boom, and a second end;
a contactor assembly coupled to the second end of the arm assembly; and
a movement control system for selectively locking the arm assembly in a fixed locking position with respect to the boom assembly, wherein the movement control system also limits movement of the arm assembly during an unlocking position.

2. The rail connector assembly of claim 1, wherein the movement control system limits rotation of the arm assembly to less than or equal to approximately 90 degrees in the unlocking position.

3. The rail connector assembly of claim 1, wherein the movement control system includes a pair of hard stops fixed to the boom assembly, the hard stops are positioned to limit the range of movement of the arm assembly about a generally vertical axis.

4. The rail connector assembly of claim 1, wherein the movement control system includes a pair of locking wings that move together and form a planar stop surface in the locking position.

5. The rail connector assembly of claim 4, wherein the movement control system includes a fluid actuator for moving the movement control system between the locking position and the unlocking position.

6. The rail connector assembly of claim 5, wherein the fluid actuator is coupled to a top surface of the boom assembly.

7. The rail connector assembly of claim 5, wherein the pair of locking wings are located distal of the fluid actuator with respect to the orientation of the mobile machine.

8. The rail connector assembly of claim 4, wherein the movement control system includes a first set of linkages connected to a first wing in the pair of wings and coupled to the fluid actuator, and a second set of linkages connected to a second wing in the pair of wings and coupled to the fluid actuator.

9. The rail connector assembly of claim 8, wherein the movement control system includes a bell crank connected to the fluid actuator, the first set of linkages, and the second set of linkages, wherein the actuation of the fluid actuator rotates the bell crank, and the rotation of the bell crank moves the linkages, causing the coordinated movement of the pair of wings.

10. A rail connector assembly for an electrically powered mobile machine, comprising:
a boom assembly with a first end and a second end;
a trailing arm assembly having a first end coupled to the boom, and a second end;
a contactor assembly coupled to the second end of the trailing arm assembly; and
a movement control system including a pair of opposing and movable locking wings movable to selectively lock the trailing arm assembly in a fixed locking position with respect to rotation about a substantially vertical axis.

11. The rail connector assembly of claim 10, wherein the movement control system limits movement of the trailing arm assembly in an unlocking position.

12. The rail connector assembly of claim 10, the movement control system limits rotation of the arm assembly to less than or equal to approximately 90 degrees in an unlocking position.

13. The rail connector assembly of claim 10, wherein the locking wings are linked together to move between the locking position and an unlocking position and form a planar stop surface in the locking position.

14. The rail connector assembly of claim 13, wherein the movement control system includes a fluid actuator for moving the locking wings between the locking position and the unlocking position.

15. The rail connector assembly of claim 14, wherein the fluid actuator is coupled to a top surface of the boom assembly.

16. The rail connector assembly of claim 14, wherein the pair of locking wings are located distal of the fluid actuator with respect to the orientation of the mobile machine.

17. The rail connector assembly of claim 14, wherein the movement control system includes a first set of linkages connected to a first wing in the pair of locking wings and coupled to the fluid actuator, and a second set of linkages connected to a second wing in the pair of locking wings and coupled to the fluid actuator.

18. A method of controlling movement of a rail connector assembly for an electrically powered mobile machine, the rail connector assembly including a boom assembly with a first end and a second end, an arm assembly having a first end coupled to the boom, and a second end, a contactor assembly coupled to the second end of the arm assembly, and a movement control system, the method comprising:
moving the movement control system between a locking position and an unlocking position, the movement to the locking position including controllably moving a pair of locking wings about a common axis.

19. The method of controlling movement of a rail connector assembly of claim 18, further comprising limiting the rotation of the arm assembly to less than or equal to approximately 90 degrees about a rotation axis.

20. The method of controlling movement of a rail connector assembly of claim 18, further comprising actuating a fluid actuator to controllably counter rotate the wings about a common axis so that the wings form a planar stop surface and each wing contacts a vertical plate of the arm assembly in the locking position.
